(19) United States
(12) Patent Application Publication
(10) Pub. No.: US 2024/0283291 A1
(43) Pub. Date: Aug. 22, 2024

(54) SENSING-BASED RADIO FREQUENCY SIGNAL TRANSMISSION

(71) Applicant: QUALCOMM Incorporated, San Diego, CA (US)

(72) Inventors: Chengjin ZHANG, San Diego, CA (US); David GAGNE, West Newbury, MA (US); Murray JARVIS, Cambridge (GB); Tingfang JI, San Diego, CA (US); Arthur MILLER, La Mesa, CA (US)

(21) Appl. No.: 18/581,840

(22) Filed: Feb. 20, 2024

Related U.S. Application Data
(60) Provisional application No. 63/486,449, filed on Feb. 22, 2023.

(51) Int. Cl. H02J 50/00; G01S 13/04; H02J 50/60

(52) U.S. Cl. CPC H02J 50/001; G01S 13/04; H02J 50/60

(57) ABSTRACT

Various aspects of the present disclosure generally relate to wireless communication. In some aspects, a transmission device may receive sensing information. The transmission device may transmit a radio frequency (RF) signal configured to power an RF energy harvesting device based at least in part on the sensing information satisfying a condition associated with a presence of an object. Numerous other aspects are described.

### CROSS-REFERENCE TO RELATED APPLICATION

This Patent Application claims priority to U.S. Provisional Patent Application No. 63/486,449, filed on Feb. 22, 2023, entitled “SENSING-BASED RADIO FREQUENCY SIGNAL TRANSMISSION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sensing-based radio frequency signal transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

Certain forms of wireless communication device may rely on harvesting energy from wireless energy transmission to power their operations. These devices are referred to herein as radio frequency (RF) energy harvesting devices and may include, for example, ambient Internet of Things devices, backscattering communication devices, and so on. In some examples, an RF energy harvesting device may harvest energy from a received RF signal configured to power the RF energy harvesting device, which may be transmitted by a transmission device.

### SUMMARY

Some aspects described herein relate to a method of wireless transmission performed by a transmission device. The method may include receiving sensing information. The method may include transmitting a radio frequency (RF) signal configured to power an RF energy harvesting device based at least in part on the sensing information satisfying a condition associated with a presence of an object.

Some aspects described herein relate to a transmission device for wireless communication. The transmission device may include a memory and one or more processors coupled to the memory. The one or more processors may be configured to receive sensing information. The one or more processors may be configured to transmit an RF signal configured to power an RF energy harvesting device based at least in part on the sensing information satisfying a condition associated with a presence of an object.

Some aspects described herein relate to a non-transitory computer-readable medium that stores a set of instructions for wireless communication by a transmission device. The set of instructions, when executed by one or more processors of the transmission device, may cause the transmission device to receive sensing information. The set of instructions, when executed by one or more processors of the transmission device, may cause the transmission device to transmit an RF signal configured to power an RF energy harvesting device based at least in part on the sensing information satisfying a condition associated with a presence of an object.

Some aspects described herein relate to an apparatus for wireless communication. The apparatus may include means for receiving sensing information. The apparatus may include means for transmitting an RF signal configured to power an RF energy harvesting device based at least in part on the sensing information satisfying a condition associated with a presence of an object.

In some aspects, a method of wireless transmission performed by a transmission device includes identifying a schedule to initiate transmission of a radio frequency (RF) signal configured to power an RF energy harvesting device; and transmitting the RF signal in accordance with the schedule.

In some aspects, an apparatus for wireless communication at a transmission device includes one or more memories; and one or more processors, coupled to the one or more memories, configured to cause the transmission device to: identify a schedule to initiate transmission of a radio frequency (RF) signal configured to power an RF energy harvesting device; and transmit the RF signal in accordance with the schedule.

In some aspects, a non-transitory computer-readable medium storing a set of instructions for wireless communication includes one or more instructions that, when executed by one or more processors of a transmission device, cause the transmission device to: identify a schedule to initiate transmission of a radio frequency (RF) signal configured to power an RF energy harvesting device; and transmit the RF signal in accordance with the schedule.

In some aspects, an apparatus for wireless communication includes means for identifying a schedule to initiate transmission of a radio frequency (RF) signal configured to power an RF energy harvesting device; and means for transmitting the RF signal in accordance with the schedule.

Aspects generally include a method, apparatus, system, computer program product, non-transitory computer-readable medium, user equipment, base station, network entity, network node, transmission device, wireless communication device, RF energy harvesting device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, RF chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example associated with backscatter communications, in accordance with the present disclosure.

FIG. 2 is a diagram illustrating an example of transmission of a radio frequency (RF) signal by a transmission device based at least in part on sensing information, in accordance with the present disclosure.

FIG. 3 is a diagram illustrating an example of transmission of an RF signal by a transmission device based at least in part on sensing information, in accordance with the present disclosure.

FIG. 4 is a diagram illustrating an example process performed, for example, by a transmission device, in accordance with the present disclosure.

FIG. 5 is a diagram of an example apparatus for wireless communication, in accordance with the present disclosure.

FIG. 6 is a diagram illustrating an example of a schedule for transmission of an RF signal configured to power an RF energy harvesting device, in accordance with the present disclosure.

FIG. 7 is a diagram illustrating an example process performed, for example, at a transmission device or an apparatus of a transmission device, in accordance with the present disclosure.

### DETAILED DESCRIPTION

A radio frequency (RF) energy harvesting device may include an ambient Internet of Things (IoT) device, an RF identification (RFID) tag, a Bluetooth low-energy (BLE) tag, a passive device, a semi-passive device, a backscattering radio, a user equipment (UE), or any other device that is powered at least in part by wireless energy transmission. An RF energy harvesting device may harvest energy from an environment of the RF energy harvesting device in order to perform operations such as transmission (e.g., backscatter transmission). In some environments, a transmission device may provide the energy using an RF signal. For example, the RF energy harvesting device may harvest the energy from the RF signal. The transmission device may be referred to as an energizer. A transmission device may transmit (e.g., radiate, wirelessly) an RF signal to provide power to RF energy harvesting devices.

Some transmission devices may be base stations, which may provide access to a radio access network (RAN) (such as according to a radio access technology). Other transmission devices may transmit an RF signal without providing access to a RAN. A transmission device may be implemented using a power source, which the transmission device may use to power RF signal transmission. The RF signal transmission of a transmission device, in this context, may use a high transmit power (e.g., higher than a typical transmit power of a UE), such as 20-30 dBm in some examples. Some power sources may be limited in terms of total available energy, available power, or the like. For example, a transmission device may be powered using a battery, which may be practical in situations where transmission devices are deployed without available hardwired power (e.g., power outlets) due, for example, to cost or safety concerns. If a transmission device transmits continuously, significant energy consumption may occur, leading to increased costs of operation and/or depletion of a battery (if the transmission device is powered by a battery), irrespective of whether an RF energy harvesting device, powered by RF signals such as the RF signal transmitted by the transmission device, is present in a coverage area of the transmission device.

Furthermore, in some examples, RF energy harvesting devices may be used to track objects in a particular environment, such as objects in a store environment, a warehouse, or a hospital. For example, an RF energy harvesting device may be affixed to an object or may be affixed to a vehicle carrying the object. Operations in these environments may tend to be predictable in the time domain. For example, it may be expected that objects are reshelved, moved, or used at certain times or for certain lengths of time. In such situations, indiscriminately activating a transmission device for continuous transmission to power RF energy harvesting devices corresponding to this object may consume power (such as battery power), thereby increasing energy consumption and maintenance requirements of the transmission device.

Some techniques described herein provide transmission of an RF signal based at least in part on sensing information. For example, a transmission device may sense a presence of an object according to sensing information obtained by the transmission device. The transmission device may transmit an RF signal configured to power an RF energy harvesting device (e.g., an Ambient IoT device) in response to sensing the presence of the object. By transmitting the RF signal in response to sensing the presence of the object, the transmission device may transmit the RF signal only when an RF energy harvesting device is likely to be in a coverage area of the transmission device (as compared to transmitting the RF signal indiscriminately), thereby reducing energy consumption, which leads to decreased cost of operation and/or battery usage. Furthermore, in some examples, transmitting the RF signal in response to sensing the presence of the object may simplify implementation of the transmission device and/or the RF energy harvesting device relative to approaches involving communication between the RF energy harvesting device and the transmission device, or approaches involving active transmission by the RF energy harvesting device to trigger or configure the RF signal. Still further, the reduction of power consumption provided by sensing-based RF signal transmission may enable the deployment of transmission devices in locations that often do not have readily available hardwired power, such as store environments, warehouses, or hospitals. In other words, the reduction of power consumption may reduce or eliminate a constraint that transmission devices must be deployed in close proximity to hardwired power in these environments. In some examples, the techniques described herein may extend the battery life of a transmission device by a factor of 10 or more.

Some techniques described herein provide scheduling of transmission of an RF signal configured to power an RF energy harvesting device. For example, a transmission device may identify a schedule to initiate transmission of an RF signal configured to power an RF energy harvesting device. The transmission device may transmit the RF signal in accordance with the schedule. Scheduling the transmission of the RF signal may simplify implementation relative to cases where presence of an object or RF energy harvesting device is sensed by the transmission device. In some aspects, the schedule may indicate time(s) at which objects or RF energy harvesting devices are predicted to be present relative to the transmission device. Scheduling the transmission of the RF signal for such times may allow for deactivation of the transmission device in times when objects or RF energy harvesting devices are unlikely to be present, thereby conserving power. This may be particularly beneficial in environments such as warehouses, hospitals, or stores, in which presence or movement of objects may be predictable in the time domain. In some aspects, the schedule may be configured for the transmission device, which enables system-wide control over multiple transmission devices, thereby improving efficiency of powering the RF energy harvesting devices. In some aspects, the transmission device may generate the schedule, such as using historical information regarding times at which objects were sensed or RF signals were transmitted. This may enable scheduling according to information gathered at the transmission device, thereby simplifying implementation of scheduling relative to externally generating or implementing the schedule.

In some examples, a transmission device may be associated with (e.g., include, be connected to) a BLE module. For example, the BLE module may be used for communication associated with controlling the transmission device. In this situation, costs may be involved in implementing a sensor to gather the sensing information described above. Some techniques described herein provide for the sensing information to be received from a BLE module of the transmission device in the form of an indication based at least in part on a received signal. For example, the received signal may be associated with a second BLE module of a second transmission device. Thus, costs may be reduced relative to implementing a sensor separate from a BLE module of a transmission device.

In some examples, a transmission device may be deployed without other transmission devices being nearby. For example, a single transmission device may be deployed for a certain coverage area without being near other transmission devices (e.g., without other transmission devices being in the same coverage area or covering the same coverage area). In this situation, gathering sensing information using signals received from other transmission devices (e.g., BLE modules of other transmission devices) may be impractical, or may constrain the flexibility of deployment of transmission devices. Some techniques described herein provide a sensor associated with (e.g., included in, connected to, communicative with) the transmission device, such as an RF sensor, a motion sensor, or a light sensor, among other examples. Such sensors may be capable of gathering sensing information (e.g., RF sensing information, motion information, or light information, among other examples) without receiving a signal transmitted by another transmission device, which improves flexibility and practicality of deploying transmission devices.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

Devices may communicate or wirelessly transfer power using the electromagnetic spectrum, which may be subdivided by frequency or wavelength into various classes, bands, channels, or the like. For example, devices of a wireless network may communicate using one or more operating bands. In 5G New Radio (NR), two initial operating bands have been identified as frequency range designations FR1 (410 megahertz (MHz)-7.125 gigahertz (GHz)) and FR2 (24.25 GHz-52.6 GHz). It should be understood that although a portion of FR1 is greater than 6 GHz, FR1 is often referred to (interchangeably) as a “Sub-6 GHz” band in various documents and articles.

A similar nomenclature issue sometimes occurs with regard to FR2, which is often referred to (interchangeably) as a “millimeter wave” band in documents and articles, despite being different from the extremely high frequency (EHF) band (30 GHz-300

GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

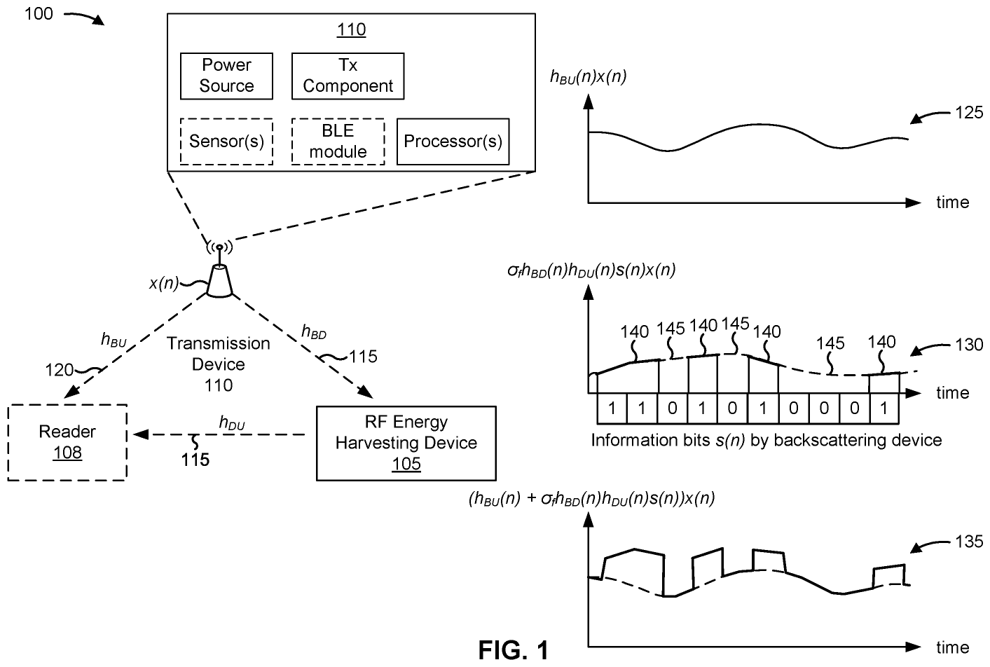

FIG. 1 is a diagram illustrating an example 100 associated with backscatter communications, in accordance with the present disclosure.

Some wireless communication devices may be considered Internet of Things (IoT) devices, such as ambient IoT devices (sometimes referred to as ultra-light IoT devices), or similar IoT devices. IoT technology may include passive IoT (e.g., NR passive IoT for 5G Advanced), semi-passive IoT, ultra-light IoT, or ambient IoT, among other examples. In passive IoT, a terminal (e.g., a radio frequency identification (RFID) device, a tag, or a similar device) may not include a battery, and the terminal may accumulate energy from radio frequency (RF) signaling. Additionally, the terminal may accumulate solar energy to supplement accumulated energy from radio signaling. In passive IoT, a communication distance may be up to 30 meters (or more) to facilitate feasible network coverage over a large area (e.g., 5000 square meters), such as in a warehouse. Moreover, the power consumption of a passive IoT terminal may be less than 0.1 milliwatts (mW) to support operation without a battery, and the terminal may be relatively inexpensive to facilitate cost-sensitive uses. A positioning accuracy of a passive IoT terminal may be approximately 3-5 meters in the horizontal and the vertical directions.

Passive IoT may be useful in connection with industrial sensors, for which battery replacement may be prohibitively difficult or undesirable (e.g., for safety monitoring or fault detection in smart factories, infrastructures, or environments). Additionally, features of passive IoT devices, such as low cost, small size, maintenance-free, durable, long lifespan, or the like, may facilitate smart logistics/warehousing (e.g., in connection with automated asset management by replacing RFID tags), such as in the context of stores, hospitals, or warehouses. Furthermore, passive IoT may be useful in connection with smart home networks for household item management, wearable devices (e.g., wearable devices for medical monitoring for which patients do not need to replace batteries), and/or environment monitoring. To achieve further cost reduction and zero-power communication, 5G+/6G wireless networks may utilize a type of passive IoT device referred to as an “ambient backscatter device” or a “backscatter device.”

An RF energy harvesting device 105 comprises a device (e.g., a tag, a sensor, a passive device such as a passive IoT device, a semi-passive device, an active device, a UE, or the like) that is powered, at least in part, by reception of an RF signal (e.g., from transmission device 110). In some examples, RF energy harvesting device 105 may employ a simplified hardware design (e.g., including a power splitter, an energy harvester, and a microcontroller) that does not include a battery, such that RF energy harvesting device 105 uses energy harvesting for power, and that does not include a radio wave generation circuit, such that RF energy harvesting device 105 is capable of transmitting information only by reflecting a radio wave. In some examples, the RF energy harvesting device 105 may include a battery, a capacitor, or another form of energy storage. In some examples, the RF energy harvesting device 105 may include a communication module, such as a BLE module, a WiFi module, or the like. As mentioned, an RF energy harvesting device 105 may be an active device (e.g., an active ambient IoT device). An active device may include a communication module and energy storage such as a battery or capacitor. The energy storage may provide power for communication via the communication module. The active device may gather energy from reception of an RF signal and/or from other sources. The communication module may be powered, at least in part, by an RF signal transmitted by a transmission device 110, such that the RF energy harvesting device 105 can communicate with the transmission device 110 or another device using the communication module as powered by the RF signal. In some aspects, the RF energy harvesting device 105 may include a radio wave generation circuit, which may be powered by reception of an RF signal and/or by energy storage of the RF energy harvesting device 105.

In some aspects, the RF energy harvesting device 105 may communicate with a reader 108 (e.g., which may include a UE, a network node, a base station, or another network device) by modulating a reflecting radio signal from a transmission device 110, referred to herein as a transmission device (e.g., a network node, or another network device). In some examples, the transmission device 110 and the reader 108 may be the same device and/or may be co-located. In some examples, a transmission device may be referred to as an energizer. In some examples, the RF energy harvesting device 105 may not communicate with a reader 108. For example, the RF energy harvesting device 105 may communicate with another device (e.g., the transmission device 110, another RF energy harvesting device, a network node). The reader 108 may be optional.

To facilitate communication of the RF energy harvesting device 105, the transmission device 110 may transmit an RF signal (e.g., an energy harvesting wave) to the RF energy harvesting device 105. When facilitating communication with the reader 108, the energy harvesting wave may be transmitted for a sufficient duration in order to enable a communication phase for a target range between the reader 108 and the RF energy harvesting device 105. Additionally, or alternatively, in some cases, a range between the transmission device 110 and the RF energy harvesting device 105 may be limited by a minimum received power for triggering energy harvesting at the RF energy harvesting device 105, such as −20 decibel milliwatts (dBm).

Once energy is sufficiently accumulated at the RF energy harvesting device 105, the RF energy harvesting device 105 may begin to communicate, or may store the energy. As one example, the RF energy harvesting device 105 may reflect the radio wave that is radiated onto the RF energy harvesting device 105 via a backscatter link 115. For example, the transmission device 110 may initiate a communication session (sometimes referred to as a query-response communication) with a query, which may be a modulating envelope of a continuous wave (CW). The RF energy harvesting device 105 may respond by backscattering of the CW. The communication session may include multiple rounds, such as for purposes of contention resolution when multiple backscatter devices respond to a query. A channel between the transmission device 110 and the RF energy harvesting device 105 of the backscatter link 115 may be associated with a first backscatter link channel response value (sometimes referred to as a first backscatter link channel coefficient or a first backscatter link gain value), h_{BD}. As described below, the RF energy harvesting device 105 may have reflection-on periods and reflection-off periods that follow a pattern that is based at least in part on the transmission of information bits by the RF energy harvesting device 105. The reader 108 may detect the reflection pattern of the RF energy harvesting device 105 and obtain the backscatter communication information via the backscatter link 115. A channel between the reader 108 and the RF energy harvesting device 105 of the backscatter link 115 may be associated with a second backscatter link channel response value (sometimes referred to as a second backscatter link channel coefficient or a second backscatter link channel gain value), h_{DU}. In addition, the transmission device 110 and the reader 108 may communicate (e.g., reference signals and/or data signals) via a direct link 120. A channel between the transmission device 110 and the reader 108 of the direct link 120 may be associated with a direct link channel response value (sometimes referred to as a direct link channel coefficient or a direct link channel gain value), h_{BU}. In some aspects, the RF energy harvesting device 105 may use the received energy to power active transmission (e.g., using an amplifier) or other operations.

In some aspects, the transmission device 110 may include a power source (e.g., a portable power source such as a battery, or a hardwired power source). The transmission device 110 may include a transmit component, such as an RF chain including a power amplifier and one or more antennas. In some aspects, the one or more antennas may be capable of beamforming (whether based on a hardware configuration of the set of antennas, or via a dynamic beamforming approach such as analog beamforming or digital beamforming) such that an RF signal transmitted by the transmission device 110 is directed to a coverage area (e.g., an area such as a portion of a sphere, an azimuth, or the like) in which RF energy harvesting devices 105 may be energized by the RF signal. In some aspects, the transmission device 110 may include or be connected to one or more sensors, such as an RF sensor, a light sensor, a motion sensor, or the like. In some aspects, the transmission device 110 may be associated with (e.g., include, be connected to, be in communication with) a BLE module, which is a module capable of transmitting and/or receiving BLE signaling, such as BLE communications. In some aspects, the BLE module may include an RF sensor. As shown, the transmission device 110 may include one or more processors, which may perform operations described herein, or be configured to perform operations described herein. For example, the one or more processors may execute instructions stored on one or more memories and/or a non-transitory computer-readable medium. The one or more processors may be coupled (e.g., operatively, communicatively, electronically, electrically) to the one or more memories. The term “processor” may refer to one or more controllers, one or more processors, or a combination thereof.

The one or more processors may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASICs), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. In some examples, the processing system may further include or be coupled with one or more modems (such as a Wi-Fi (for example, IEEE compliant) modem, a cellular (for example, 3GPP 4G LTE, 5G, or 6G compliant) modem) modem, or a Bluetooth (for example, BLE) modem. In some implementations, one or more processors of the processing system may include or implement one or more of the modems. The processing system may further include or be coupled with one or multiple radios (collectively “the radio”), one or multiple RF chains, or one or multiple transceivers (where the transmission device 110′s transmit component may include one or more RF chains and/or one or more transceivers), each of which may in turn be coupled with one or more of multiple antennas. In some implementations, one or more processors of the processing system include or implement one or more of the radios, RF chains or transceivers.

If performing backscattering communication, the RF energy harvesting device 105 may use an information modulation scheme, such as amplitude shift keying (ASK) modulation or on-off keying (OOK) modulation. For ASK or OOK modulation, the RF energy harvesting device 105 may switch on reflection when transmitting an information bit “1” and switch off reflection when transmitting an information bit “0.” In backscatter communication, the transmission device 110 may transmit a particular radio wave (e.g., a reference signal or a data signal, such as a physical downlink shared channel (PDSCH)), which may be denoted as x(n). The reader 108 may receive this radio wave, x(n), directly from the transmission device 110 via the direct link 120, as well as from the RF energy harvesting device 105 modulating and reflecting the radio wave to the reader 108 via the backscatter link 115. The signal received at the reader 108 via the direct link 120, denoted as h_{BU}(n)x(n) and indicated by reference number 125, is the product of the radio wave transmitted by the transmission device 110, x(n), multiplied by the direct link channel response value, h_{BU}, plus any signal noise. The information bits signal of the RF energy harvesting device 105 may be denoted as s(n) where s(n)∈{0,1}. Accordingly, the signal received at the reader 108 via the backscatter link 115, denoted as σ_{f}h_{BD}(n)h_{DU}(n)s(n)x(n) and indicated by reference number 130, is the product of the signal transmitted by the transmission device 110, x(n), multiplied by the first backscatter link channel response value, h_{BD}, the second backscatter link channel response value, h_{DU}, the information bits signal from the RF energy harvesting device 105, s(n), and a reflection coefficient associated with the RF energy harvesting device 105, σ_{f}, plus any noise.

Thus, if performing backscattering communication, the resulting signal received at the reader 108, which is the superposition of the signal received via the direct link 120 and the signal received via the backscatter link 115, may be denoted as y(n) where y(n)=(h_{BU}(n)+σ_{f}h_{BD}(n)h_{DU}(n)s(n))x(n)+noise. This signal, y(n), is shown by reference number 135. As shown, when s(n)=0 (indicated by reference number 145 in the plot shown at reference number 130), the RF energy harvesting device 105 may switch off reflection, such that the signal component σ_{f}h_{BD}(n)h_{DU}(n)s(n) equals zero, and thus the reader 108 receives only the direct link 120 signal (e.g., y(n)=h_{BU}(n)x(n)+noise). When s(n)=1 (indicated by reference number 140 in the plot shown at reference number 130), the RF energy harvesting device 105 may switch on reflection, such that signal component σ_{f}h_{BD}(n)h_{DU}(n)s(n) equals σ_{f}h_{BD}(n)h_{DU}(n), and thus the reader 108 receives a superposition of both the direct link 120 signal and the backscatter link 115 signal (e.g., y(n)=(h_{BU}(n)+σ_{f}h_{BD}(n)h_{DU}(n))+noise). To receive the information bits transmitted by the RF energy harvesting device 105, the reader 108 may first decode x(n) based at least in part on the direct link channel response value of h_{BU}(n) by treating the backscatter link 115 signal as interference. The reader 108 may then detect the existence of the signal component σ_{f}h_{BD}(n)h_{DU}(n)x(n) by subtracting h_{BU}(n)x(n) from y(n). In some cases, the RF energy harvesting device 105 may not maintain a state from communication session to communication session except of what is stored in the RF energy harvesting device 105 memory, such as an electronic product code (EPC) associated with RF energy harvesting device 105 or similar information.

Some IoT devices may be referred to as semi-passive IoT devices, because communication between a reader and the IoT device does not need to be preceded by an energy harvesting waveform. For example, semi-passive IoT devices may include a battery or similar energy source that can power the receiver and/or logic circuit. For such devices, energy harvesting may still be triggered in some cases, such as for long-range communications. In such examples, a rectifier circuit of the IoT device may have a warm start from the battery or other energy source, and thus may be associated with a lower minimum received power requirement than passive IoT devices (e.g., −30 dBm rather than −20 dBm). Nonetheless, long-range communications may require battery power spend to energize each decoding. More particularly, for long-range communications in which an energy harvesting rate is lower than a decoding circuit requirement, such as when the energy harvesting rate is below −30 dBm, the semi-passive IoT device may expend battery power to energize each decoding. Thus, continuous IoT device monitoring, such as for purposes of receiving a long-distance query communication, may result in excessive battery drain at the IoT device.

In that regard, passive and semi-passive IoT devices may be inherently limited for certain applications. For example, passive IoT devices may be associated with a low cost and form factor because there is no need for an RF chain at the IoT device. However, these devices require an energy harvesting waveform, limiting the application of such passive IoT devices to short-distance communications. Although semi-passive IoT devices may eliminate the need for an energy harvesting waveform and/or may enable long-distance communications, such devices increase cost and complexity because the devices require the use of a battery or similar energy source. Moreover, because passive and semi-passive devices may be associated with a communication session that is initiated by the RF source, these devices may be inherently limited for use in sensing scenarios or similar latency-critical applications that require aperiodic traffic, and the devices may not scale well for use in high IoT density applications.

In some cases, an ambient IoT device (sometimes referred to as an ultra-light IoT device) may be employed in order to overcome some of the deficiencies of passive and semi-passive IoT devices. An ambient IoT device may be a device that is capable of transmitting an uplink trigger, and thus may initiate a communication session from the IoT device side. For example, an ambient IoT device may be associated with uplink transmissions that do not utilize a PA (e.g., a transmission in the range of 0 to 5 dBm), and for which there is limited transmission capability, such as an ability to simply transmit a preamble transmission to indicate uplink traffic. Ambient IoT devices, passive devices, and semi-passive devices are referred to herein as RF energy harvesting devices (though an RF energy harvesting device can include another form of device that is capable of harvesting RF energy from an RF signal to power operations of the device).

As indicated above, FIG. 1 is provided as an example. Other examples may differ from what is described with respect to FIG. 1.

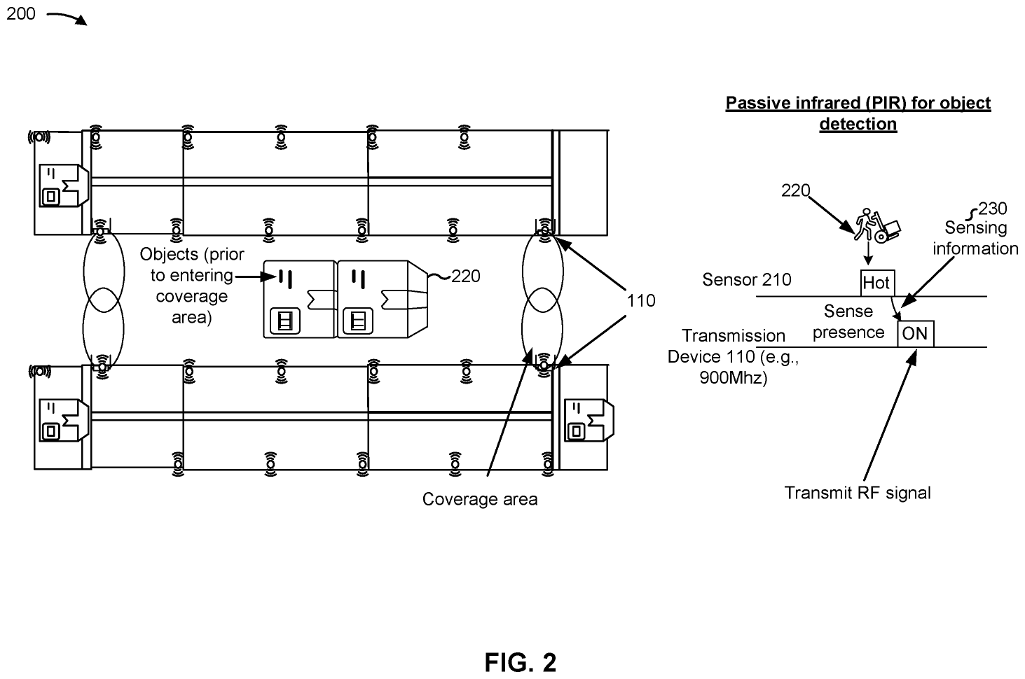

FIG. 2 is a diagram illustrating an example of transmission of an RF signal by a transmission device (e.g., a transmission device 110) in an environment 200 based at least in part on sensing information 230, in accordance with the present disclosure. A transmission device 110 may sense a presence of an object 220 using sensing information 230 from a sensor 210. The sensing information 230 may include any information that can be gathered by a sensor 210 or an RF receiver, or may include information derived from such information. In example 200, the sensor 210 is a passive infrared sensor, though one or more types of sensors may be implemented (e.g., an RF sensor, a motion sensor, a light sensor) as, in addition to, or in combination with the passive infrared sensor.

As shown, the sensor 210 provides sensing information 230 (e.g., an indication that an object 220 is present in a coverage area of the sensor 210 and/or the transmission device 110, or a sensor signal that can be used to identify that an object 220 is present) to the transmission device. Thus, the sensor may be associated with the transmission device. In some examples, the sensor 210 may be at the transmission device. For example, the sensor 210 may be included in the transmission device or connected to the transmission device. The sensor 210 may be separate from a transmit component that transmits an RF signal. In some examples, the sensing information 230 may satisfy a condition (as indicated by “Hot”). The condition may be associated with (e.g., may indicate) the presence of an object 220 in a coverage area of an RF signal that can be transmitted by the transmission device 110. For example, the condition may be satisfied based at least in part on the object 220 being present in the coverage area of the sensor 210. In some aspects, the condition may be based at least in part on a threshold relating to a motion value (e.g., if a threshold level of motion is detected, the condition is satisfied), a light value (e.g., if a threshold change in light is detected, the condition is satisfied), an RF value (e.g., if a threshold change in RF conditions is detected, the condition is satisfied), a channel measurement (e.g., if a channel measurement is lower than a threshold, the condition is satisfied), a signal strength (e.g., if a received signal strength is lower than a threshold, the condition is satisfied), or the like. For example, the sensor information 210 may include a signal from a motion sensor, a signal from a light sensor indicating a level of illuminance, an indication from a passive infrared sensor that the object is present in a coverage are of the passive infrared sensor, or the like. It should be noted that the transmission device can sense presence of an object according to sensing information without performing a sensing operation.

As shown, the transmission device 110 (e.g., a transmit component of the transmission device 110, which may be separate from or a different component than the sensor 210) may transmit an RF signal in response to sensing the presence of the object 220. For example, the transmission device 110 may initiate transmission of the RF signal in response to sensing the presence of the object 220. The RF signal may be configured to power an RF energy harvesting device. For example, the transmission device 110 may be configured to transmit RF signals at a strength sufficient to power an RF energy harvesting device in a coverage area of the RF signals (e.g., at least 20 dBm, in some examples). In some aspects, the RF signal may be in a 900 MHz band, and may have a maximum equivalent isotropic radiated power (EIRP) of 36 dBm. In some aspects, the RF signal may be in a 2.4 GHz band, and may have a maximum EIRP of 20 dBm.

In some aspects, the transmission device 110 may sense the presence of the object 220, and/or may transmit (or initiate transmission of) the RF signal, independent of receiving a transmission (e.g., an RF transmission) from the RF energy harvesting device. For example, the sensor 210 may enable the transmission device 110 to sense the presence of the object 220 while the RF energy harvesting device is powered down or in a dormant or non-transmitting state. The transmission device 110 may initiate transmission of the RF signal while the RF energy harvesting device is powered down, or independently of whether the RF energy harvesting device is powered down. Thus, the techniques described herein can be used to initiate transmission from a transmission device 110 to power an RF energy harvesting device, even in situations where the RF energy harvesting device is completely powered down or incapable of transmission (e.g., RF transmission).

In some examples, the environment 200 may be a store. For example, an object 220 may include a cart carrying merchandise, a piece of merchandise, a worker or other individual associated with the store, or the like. The RF energy harvesting device may include a tag of the cart, merchandise, or individual. In some examples, the environment 200 may be a warehouse. For example, the object 220 may include a cart carrying stock, a piece of stock, a worker or other individual associated with the warehouse, or the like. The RF energy harvesting device may include a tag of the cart, stock, or individual. In some examples, the environment 200 may be a hospital. For example, the object 220 may include an individual associated with the hospital, a medical device (e.g., any instrument, apparatus, implement, machine, appliance, implant, reagent for in vitro use, software, material or other similar or related article, to be used, alone or in combination, for a medical purpose), an item associated with a billable event, or the like. The RF energy harvesting device may include a tag of the individual, medical device, or item.

In some aspects, a sensor 210 may be associated with multiple transmission devices 110. The sensor 210 may transmit sensing information 230 to the multiple transmission devices 110, and the multiple transmission devices 110 may each transmit an RF signal in accordance with the sensing information 230. Additionally, or alternatively, a particular transmission device 110 may selectively transmit an RF signal based at least in part on the sensing information 230. For example, the sensing information may indicate a direction or location of an object, and a transmission device 110 may transmit the RF signal only if the direction or location corresponds to a coverage area of the transmission device 110.

In some aspects, the transmission device 110 may avoid transmission of the RF signal while the transmission device 110 waits for the presence of the object to be sensed. For example, the transmission device 110 may transmit the RF signal only while the presence of the object is sensed. As another example, the transmission device 110 may set the transmit component to an off state (in which one or more components of the transmit component are powered down or the transmit component is inactive) until the presence of the object is sensed. As another example, the transmit component may not transmit the RF signal while the transmission device waits for the presence of the object to be sensed.

In some aspects, the transmission device 110 may determine that the presence of the object is no longer sensed and/or sense an absence of the object. For example, the transmission device 110 may receive second sensing information 230 after initiating transmission of the RF signal. The second sensing information may not indicate the presence of the object 220 and/or indicate the absence of the object 220. For example, the transmission device 110 may not sense the presence of the object 220 using the second sensing information and/or sense the absence of the object 220 using the second sensing information. The transmission device 110 may cease transmission of the RF signal in response to not sensing the presence of the object 220 and/or sensing the absence of the object 220. For example, the transmission device 110 may set the transmit component to the off state. As another example, the transmission device 110 may not transmit the RF signal. In some aspects, the transmission device 110 may cease transmission of the RF signal after a configured length of time. The configured length of time may be configured, for example, by a controller of the transmission device 110, an administrator, or the like. In some aspects, the transmission device 110 may receive network signaling indicating to cease transmission of the RF signal. The network signaling may include, for example, radio resource control signaling, downlink control information, medium access control information, backhaul interface (e.g., F1) signaling, non-access stratum signaling, signaling using a local area or personal area network protocol, or the like.

As indicated above, FIG. 2 is provided as an example. Other examples may differ from what is described with regard to FIG. 2.

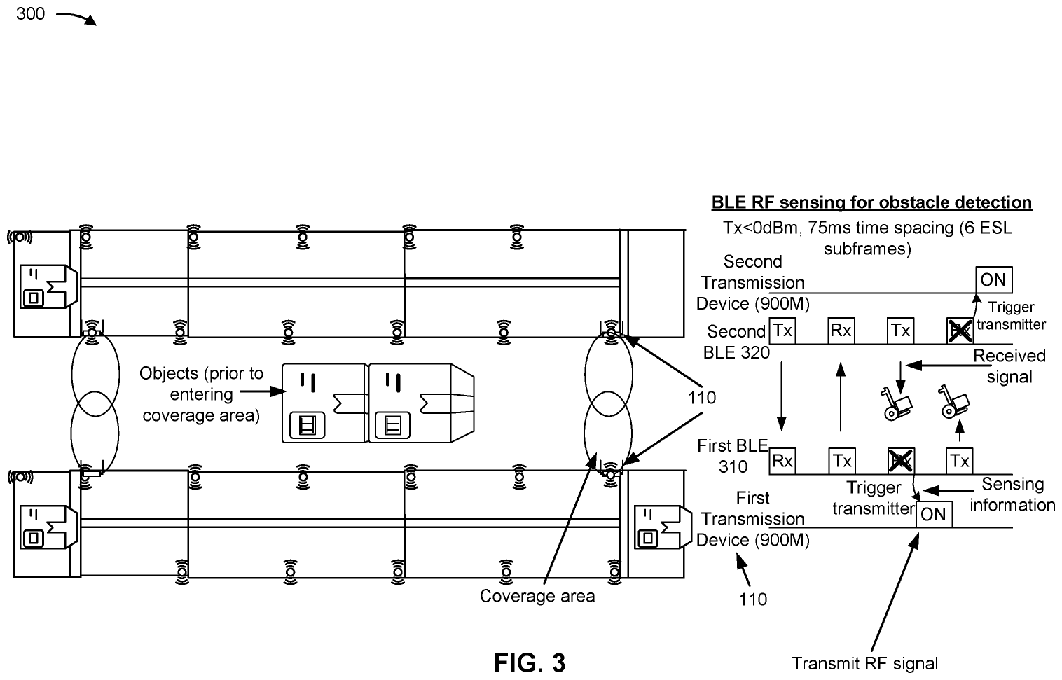

FIG. 3 is a diagram illustrating an example 300 of transmission of an RF signal by a transmission device (e.g., a transmission device 110) based at least in part on sensing information, in accordance with the present disclosure. A transmission device (e.g., transmission device 110) may receive sensing information from a BLE module 310 associated with the transmission device. As shown, the BLE module 310 provides sensing information (e.g., an indication that an object is present in a coverage area of the passive infrared sensor and/or the transmission device) to the transmission device. The sensing information may be derived from a received signal. The received signal may be transmitted by a second BLE module 320 of a second transmission device. For example, based on the BLE module 310 receiving or not receiving a signal transmitted by the second BLE module 320, the BLE module 310 or the transmission device may derive the sensing information. The received signal may include any signal that can be transmitted by a BLE module 310/320.

For example, the sensing information may indicate that the received signal was at least partially blocked by an object in a coverage area of the transmission device. Thus, the sensing information may satisfy a condition. The condition may be associated with (e.g., indicate) the presence of an object in a coverage area of an RF signal that can be transmitted by the transmission device. For example, the condition may be based at least in part on a channel measurement, a signal strength, an impulse measurement (e.g., if an impulse of the channel is lower than a threshold, the condition is satisfied), or the like. In some aspects, the condition may be satisfied when the received signal is not received (e.g., due to blockage by the object). For example, the first BLE module 310 may fail to receive the signal at a predetermined time, a configured time, or a time negotiated between BLE modules, and may provide the sensing information indicating that the first BLE module 310 failed to receive the signal. In this example, the condition may be that the first BLE module 310 failed to receive the signal. The RF signal may be configured to power an RF energy harvesting device. For example, the transmission device may be an energizer that is configured to transmit RF signals at a strength sufficient to energize an RF energy harvesting device in a coverage area of the RF signals.

As indicated above, FIG. 3 is provided as an example. Other examples may differ from what is described with regard to FIG. 3.

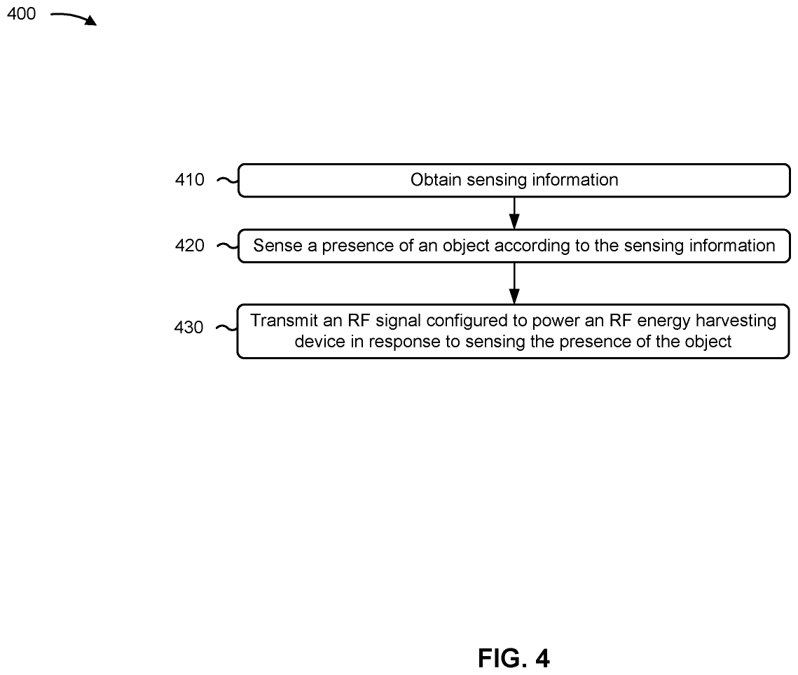

FIG. 4 is a diagram illustrating an example process 400 performed, for example, at a transmission device or an apparatus of a transmission device, in accordance with the present disclosure. Example process 400 is an example where the apparatus or the transmission device (e.g., the transmission device of FIGS. 2-3, transmission device 110) performs operations associated with sensing-based radio frequency signal transmission.

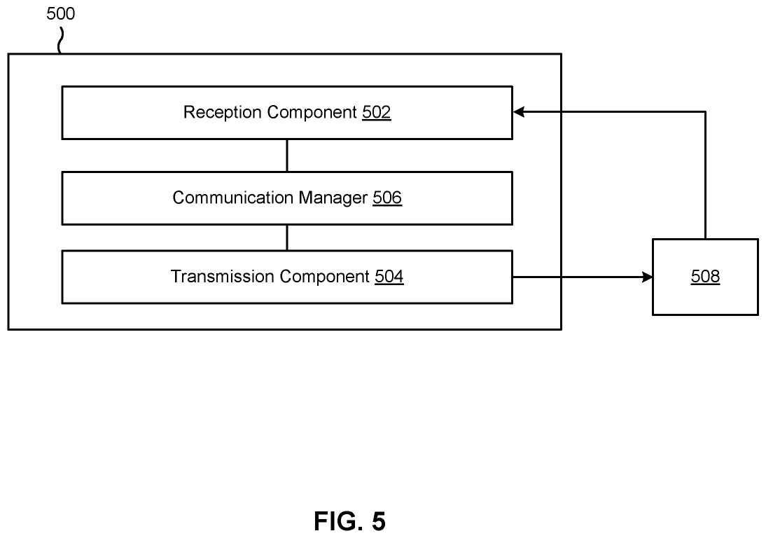

As shown in FIG. 4, in some aspects, process 400 may include obtaining sensing information (block 410). For example, the transmission device or the apparatus (e.g., using reception component 502, an interface with a sensor or BLE module, and/or communication manager 506, depicted in FIG. 5) may receive or determine sensing information, as described above.

As shown in FIG. 4, in some aspects, process 400 may include sensing a presence of an object according to the sensing information (block 420). For example, the transmission device or the apparatus (e.g., using communication manager 506, depicted in FIG. 5) may sense a presence of an object according to the sensing information, as described above in connection with FIGS. 2 and 3.

As further shown in FIG. 4, in some aspects, process 400 may include transmitting an RF signal configured to power an RF energy harvesting device in response to sensing the presence of the object (block 430). For example, the transmission device or the apparatus (e.g., using transmission component 504, the Tx component of transmission device 110 of FIG. 1, and/or communication manager 506, depicted in FIG. 5) may transmit an RF signal configured to power an RF energy harvesting device (e.g., RF energy harvesting device 105) in response to sensing the presence of the object, as described above. As another example, the transmission device or the apparatus may initiate transmission of the RF signal.

Process 400 may include additional aspects, such as any single aspect or any combination of aspects described below and/or in connection with one or more other processes described elsewhere herein.

In a first aspect, receiving the sensing information further comprises receiving the sensing information from a sensor.

In a second aspect, alone or in combination with the first aspect, the sensor comprises at least one of a motion sensor, a light sensor, or an RF sensor.

In a third aspect, alone or in combination with one or more of the first and second aspects, the condition being satisfied indicates that the object is present in a coverage area of the RF signal.

In a fourth aspect, alone or in combination with one or more of the first through third aspects, receiving the sensing information further comprises receiving, from a passive infrared sensor, an indication that the object is present in a coverage area of the passive infrared sensor, wherein the condition is satisfied based at least in part on the object being present in the coverage area of the passive infrared sensor, as described in connection with FIG. 2.

In a fifth aspect, alone or in combination with one or more of the first through fourth aspects, receiving the sensing information further comprises receiving, from a BLE module of the transmission device, an indication based at least in part on a received signal, the sensing information comprising the indication, wherein the condition is satisfied based at least in part on the indication, as described in connection with FIG. 3.

In a sixth aspect, alone or in combination with one or more of the first through fifth aspects, the received signal is associated with a second BLE module of a second transmission device.

In a seventh aspect, alone or in combination with one or more of the first through sixth aspects, process 400 includes ceasing transmission of the RF signal after a configured length of time.

In an eighth aspect, alone or in combination with one or more of the first through seventh aspects, process 400 includes receiving second sensing information after transmitting the RF signal, and ceasing transmission of the RF signal based at least in part on the second sensing information failing to satisfy the condition.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example apparatus 500 for wireless communication, in accordance with the present disclosure. The apparatus 500 may be a transmission device (e.g., the transmission device of FIGS. 2-3, a transmission device 110), or a transmission device may include the apparatus 500. In some aspects, the apparatus 500 includes a reception component 502, a transmission component 504, and/or a communication manager 506, which may be in communication with one another (for example, via one or more buses and/or one or more other components). As shown, the apparatus 500 may communicate with another apparatus 508, such as a sensor, a BLE module, a UE or a network node (such as a central unit (CU), a distributed unit (DU), a radio unit (RU), or a base station), using the reception component 502, the transmission component 504, or an interface with the other apparatus 508.

In some aspects, the apparatus 500 may be configured to perform one or more operations described herein in connection with FIGS. 2-3. Additionally, or alternatively, the apparatus 500 may be configured to perform one or more processes described herein, such as process 400 of FIG. 4, or a combination thereof. In some aspects, the apparatus 500 and/or one or more components shown in FIG. 5 may include one or more components of the transmission device (e.g., transmission device 110) described in connection with FIG. 1. Additionally, or alternatively, one or more components shown in FIG. 5 may be implemented within one or more components described in connection with FIG. 1. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 502 (or an interface) may receive communications, such as reference signals, control information, data communications, sensing information, or a combination thereof, from the apparatus 508. The reception component 502 may provide received communications to one or more other components of the apparatus 500. In some aspects, the reception component 502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 500. In some aspects, the reception component 502 may include one or more antennas, a modem, a demodulator, a multiple-input multiple-output (MIMO) detector, a receive processor, a controller/processor, a memory, an interface, or a combination thereof, of a transmission device.

The transmission component 504 (or an interface) may transmit communications, such as reference signals, control information, data communications, or a combination thereof, to the apparatus 508. In some aspects, one or more other components of the apparatus 500 may generate communications and may provide the generated communications to the transmission component 504 for transmission to the apparatus 508. In some aspects, the transmission component 504 may perform signal processing on the generated communications (such as filtering, amplification, modulation, digital-to-analog conversion, multiplexing, interleaving, mapping, or encoding, among other examples), and may transmit the processed signals to the apparatus 508. In some aspects, the transmission component 504 may transmit an RF signal configured to power an RF energy harvesting device. In some aspects, the transmission component 504 may be co-located with the reception component 502 in a transceiver.

The communication manager 506 may support operations of the reception component 502 and/or the transmission component 504. For example, the communication manager 506 may receive information associated with configuring reception of communications by the reception component 502 and/or transmission of communications by the transmission component 504. Additionally, or alternatively, the communication manager 506 may generate and/or provide control information to the reception component 502 and/or the transmission component 504 to control reception and/or transmission of communications.

The reception component 502 may receive sensing information. The transmission component 504 may transmit an RF signal configured to power an RF energy harvesting device based at least in part on the sensing information satisfying a condition associated with a presence of an object.

The communication manager 506 may cease transmission of the RF signal after a configured length of time.

The reception component 502 may receive second sensing information after transmitting the RF signal.

The communication manager 506 may cease transmission of the RF signal based at least in part on the second sensing information failing to satisfy the condition.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

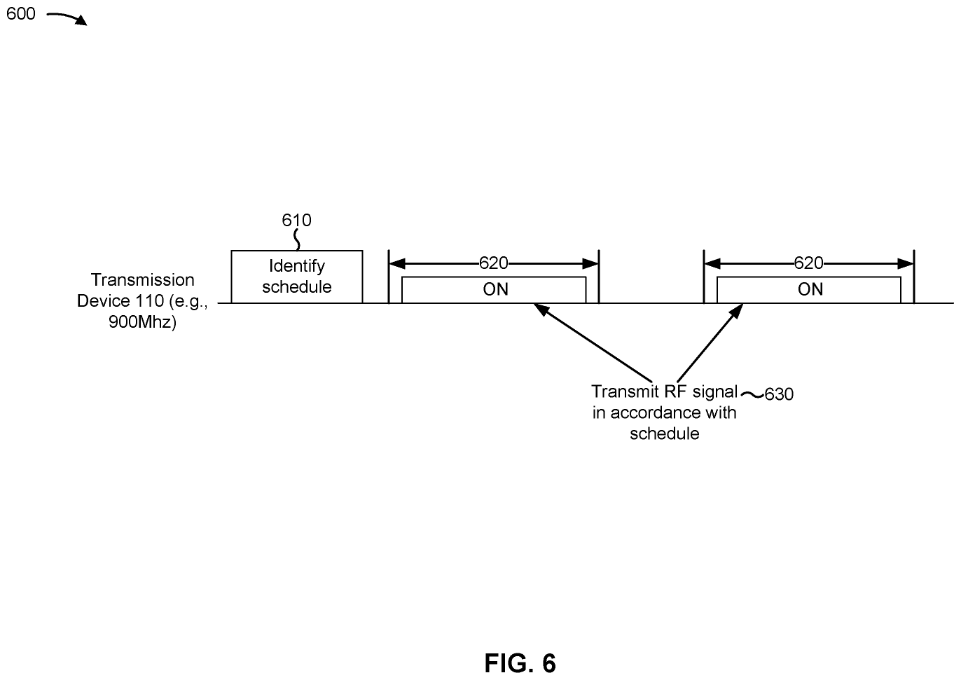

FIG. 6 is a diagram illustrating an example 600 of a schedule for transmission of an RF signal configured to power an RF energy harvesting device, in accordance with the present disclosure. As shown, example 600 includes a transmission device 110 and an RF energy harvesting device (e.g., RF energy harvesting device 105). In some aspects, the RF energy harvesting device may be affixed to or otherwise associated with an object (e.g., object 220). The transmission device 110 and the RF energy harvesting device may be included in or otherwise associated with an environment (e.g., environment 200), which may include, for example, a store, a hospital, or a warehouse.

As shown by reference number 610, the transmission device 110 may identify a schedule. The schedule may indicate one or more time intervals 620 in which transmission of RF signals configured to power the RF energy harvesting device is permitted. For example, the time interval 620 may correspond to a time at which objects are predicted to be present relative to the transmission device 110 (e.g., in a coverage area of the transmission device 110). As another example, the time interval 620 may correspond to a time at which objects are predicted to be present in the environment, such as operating hours or restocking time of a store, or a loading or unloading time of a warehouse.

In some aspects, the transmission device 110 may generate the schedule. For example, the transmission device 110 may generate the schedule according to historical information regarding times at which objects were sensed by the transmission device 110 or RF signals were transmitted by the transmission device 110. More particularly, the transmission device 110 may identify a time interval 620 in which objects are repeatedly sensed (e.g., in a threshold number of days, over a threshold number of occurrences, with a threshold probability), and may generate a schedule that indicates to transmit the RF signal during the time interval 620.

In some aspects, the transmission device 110 may receive configuration information indicating the schedule. For example, a controller (e.g., another transmission device 110, an administration device) may transmit, and the transmission device 110 may receive, the configuration information. The configuration information may indicate the schedule. For example, the configuration information may identify the time interval 620, a periodicity of the schedule, a direction for the RF signal, or the like.

In some aspects, the controller may generate schedules for multiple transmission devices 110. For example, the controller may receive or obtain information regarding presence of objects associated with each of the multiple transmission devices 110. Using this information, the controller may generate schedules for the multiple transmission devices 110. For example, the schedules may cause the transmission devices 110 to transmit in a common time interval 620 in which objects have been observed to be in the presence of any of the transmission devices 110. As another example, different transmission devices 110 may have different schedules. For example, a schedule of a first transmission device 110 may indicate a time interval 620 in which objects have historically been sensed near the first transmission device 110, and a schedule of a second transmission device 110 may indicate a time interval 620 in which objects have historically been sensed near the second transmission device 110.

As shown by reference number 630, the transmission device 110 may transmit the RF signal in accordance with the schedule. For example, the transmission device 110 may transmit the RF signal in the time interval 620 identified by the schedule. In some aspects, the transmission device 110 may transmit continuously in the time interval 620. In some other aspects, the transmission device 110 may transmit in the time interval 620 based on sensing presence of an object. For example, the time interval 620 may be a time interval in which the transmission device 110 performs sensing to identify the presence of an object, and the transmission device 110 may transmit the RF signal if the transmission device 110 senses the presence of the object during the time interval 620. The sensing to identify the presence of an object, and transmission of an RF signal in response to sensing the presence of the object, is described in connection with FIGS. 2 and 3.

As indicated above, FIG. 6 is provided as an example. Other examples may differ from what is described with regard to FIG. 6.

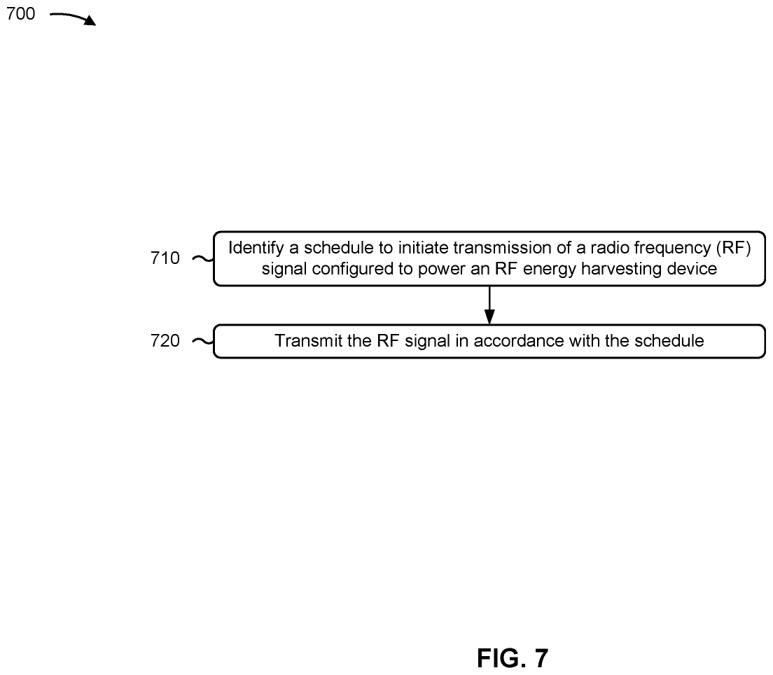

FIG. 7 is a diagram illustrating an example process 700 performed, for example, at a transmission device or an apparatus of a transmission device, in accordance with the present disclosure. Example process 700 is an example where the apparatus or the transmission device (e.g., the transmission device of FIGS. 2-3, transmission device 110) performs operations associated with sensing-based radio frequency signal transmission.

As shown in FIG. 7, in some aspects, process 700 may include identifying a schedule to initiate transmission of a radio frequency (RF) signal configured to power an RF energy harvesting device (block 710). For example, the transmission device (e.g., using reception component 502, an interface with a sensor or BLE module, and/or communication manager 506, depicted in FIG. 5) may identify a schedule to initiate transmission of a RF signal configured to power an RF energy harvesting device (e.g., RF energy harvesting device 105), as described above.

As further shown in FIG. 7, in some aspects, process 700 may include transmitting the RF signal in accordance with the schedule (block 720). For example, the transmission device or the apparatus (e.g., using transmission component 504, the Tx component of transmission device 110 of FIG. 1, and/or communication manager 506, depicted in FIG. 5) may transmit the RF signal in accordance with the schedule, as described above. As another example, the transmission device or the apparatus may trigger transmission of the RF signal.

Process 700 may include additional aspects, such as any single aspect or any combination of aspects described below and/or in connection with one or more other processes described elsewhere herein.

In a first aspect, the schedule indicates a time at which objects or RF energy harvesting devices are predicted to be present relative to the transmission device.

In a second aspect, alone or in combination with the first aspect, the schedule indicates a time interval in which transmission of RF signals configured to power the RF energy harvesting device is permitted.

In a third aspect, alone or in combination with one or more of the first and second aspects, identifying the schedule further comprises receiving configuration information indicating the schedule.

In a fourth aspect, alone or in combination with one or more of the first through third aspects, identifying the schedule further comprises generating the schedule.

In a fifth aspect, alone or in combination with one or more of the first through fourth aspects, generating the schedule further comprises generating the schedule according to historical information regarding times at which objects were sensed or RF signals were transmitted.

In a sixth aspect, alone or in combination with one or more of the first through fifth aspects, the RF signal is in a 2.4 gigahertz band and has an effective isotropic radiated power of up to 20 decibel milliwatts.

In a seventh aspect, alone or in combination with one or more of the first through sixth aspects, the RF signal is in a 900 megahertz band and has an effective isotropic radiated power of up to 34 decibel milliwatts.

In an eighth aspect, alone or in combination with one or more of the first through seventh aspects, process 700 includes transmitting the RF signal in accordance with sensing the presence of the object.

In a ninth aspect, alone or in combination with one or more of the first through eighth aspects, process 700 includes obtaining the sensing information from a sensor.

In a tenth aspect, alone or in combination with one or more of the first through ninth aspects, transmitting the RF signal further comprises transmitting the RF signal using a transmit component, wherein the sensor is separate from the transmit component.

In an eleventh aspect, alone or in combination with one or more of the first through tenth aspects, the sensor comprises at least one of a motion sensor, a light sensor, or an RF sensor.

In a twelfth aspect, alone or in combination with one or more of the first through eleventh aspects, the sensing information comprises a signal from a motion sensor indicating the presence of the object.

In a thirteenth aspect, alone or in combination with one or more of the first through twelfth aspects, the sensing information comprises a signal from a light sensor indicating that a level of illuminance is lower than a threshold.

In a fourteenth aspect, alone or in combination with one or more of the first through thirteenth aspects, process 700 includes receiving, from a passive infrared sensor, an indication that the object is present in a coverage area of the passive infrared sensor, the sensing information comprising the indication.

In a fifteenth aspect, alone or in combination with one or more of the first through fourteenth aspects, process 700 includes receiving, from a Bluetooth low-energy (BLE) module of the transmission device, an indication based at least in part on a received signal, the sensing information comprising the indication.

In a sixteenth aspect, alone or in combination with one or more of the first through fifteenth aspects, the received signal is associated with a second BLE module of a second transmission device.

In a seventeenth aspect, alone or in combination with one or more of the first through sixteenth aspects, sensing the presence of the object further comprises sensing the presence of the object without receiving a transmission from the RF energy harvesting device.

In an eighteenth aspect, alone or in combination with one or more of the first through seventeenth aspects, sensing the presence of the object further comprises sensing the presence of the object while the RF energy harvesting device is in a dormant state.

In a nineteenth aspect, alone or in combination with one or more of the first through eighteenth aspects, the RF energy harvesting device is affixed to or associated with an object.

In a twentieth aspect, alone or in combination with one or more of the first through nineteenth aspects, the object comprises at least one of a cart, merchandising, an individual, or warehouse stock.

In a twenty-first aspect, alone or in combination with one or more of the first through twentieth aspects, a time interval indicated by the schedule corresponds to operating hours or a restocking time of a store.

In a twenty-second aspect, alone or in combination with one or more of the first through twenty-first aspects, a time interval indicated by the schedule corresponds to a loading or unloading time of a warehouse.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The following provides an overview of some Aspects of the present disclosure:

Aspect 1: A method of wireless transmission performed by a transmission device, comprising: sensing a presence of an object according to sensing information obtained by the transmission device; and transmitting a radio frequency (RF) signal configured to power an RF energy harvesting device in response to sensing the presence of the object.

Aspect 2: The method of Aspect 1, wherein transmitting the RF signal further comprises initiating transmission of the RF signal in response to sensing the presence of the object.

Aspect 3: The method of any of Aspects 1-2, further comprising obtaining the sensing information from a sensor associated with the transmission device.

Aspect 4: The method of Aspect 3, wherein transmitting the RF signal further comprises transmitting the RF signal using a transmit component, wherein the sensor is separate from the transmit component.

Aspect 5: The method of Aspect 3, wherein the sensor comprises at least one of: a motion sensor, a light sensor, or an RF sensor.

Aspect 6: The method of any of Aspects 1-5, wherein the sensing information comprises a signal from a motion sensor associated with the transmission device indicating the presence of the object.

Aspect 7: The method of any of Aspects 1-6, wherein the sensing information comprises a signal from a light sensor associated with the transmission device indicating that a level of illuminance is lower than a threshold.

Aspect 8: The method of any of Aspects 1-7, further comprising receiving, from a passive infrared sensor associated with the transmission device, an indication that the object is present in a coverage area of the passive infrared sensor, the sensing information comprising the indication.

Aspect 9: The method of any of Aspects 1-8, further comprising receiving, from a Bluetooth low-energy (BLE) module of the transmission device, an indication based at least in part on a received signal, the sensing information comprising the indication.

Aspect 10: The method of Aspect 9, wherein the received signal is associated with a second BLE module of a second transmission device.

Aspect 11: The method of any of Aspects 1-10, further comprising ceasing transmission of the RF signal after a configured length of time.

Aspect 12: The method of any of Aspects 1-11, further comprising: receiving second sensing information after initiating transmission of the RF signal, wherein the second sensing information does not indicate the presence of the object; and ceasing transmission of the RF signal after receiving the second sensing information.

Aspect 13: The method of any of Aspects 1-12, further comprising avoiding transmission of the RF signal while the transmission device waits for the presence of the object to be sensed.

Aspect 14: The method of any of Aspects 1-13, wherein sensing the presence of the object further comprises sensing the presence of the object independently of receiving a transmission from the RF energy harvesting device.

Aspect 15: The method of any of Aspects 1-14, wherein sensing the presence of the object further comprises sensing the presence of the object while the RF energy harvesting device is in a dormant state.

Aspect 16: The method of any of Aspects 1-15, wherein transmitting the RF signal further comprises transmitting the RF signal in accordance with a schedule.

Aspect 17: The method of Aspect 16, wherein the schedule indicates a time interval in which transmission of RF signals configured to power the RF energy harvesting device is permitted.

Aspect 18: The method of Aspect 16, further comprising receiving configuration information indicating the schedule.

Aspect 19: The method of Aspect 16, further comprising generating the schedule.

Aspect 20: The method of Aspect 19, wherein generating the schedule further comprises generating the schedule according to historical information regarding times at which objects were sensed or RF signals were transmitted.

Aspect 21: The method of Aspect 16, wherein the schedule is associated with a time at which objects or RF energy harvesting devices are predicted to be present relative to the transmission device.

Aspect 22: The method of any of Aspects 1-21, wherein the RF signal is in a 2.4 gigahertz band and has a transmit power of approximately 20 decibel milliwatts.

Aspect 23: The method of any of Aspects 1-22, wherein the RF signal is in a 900 megahertz band and has a transmit power of approximately 30 decibel milliwatts.

Aspect 24: The method of any of Aspects 1-23, wherein the RF energy harvesting device is affixed to or associated with the object.

Aspect 25: The method of any of Aspects 1-24, wherein the object comprises at least one of: a cart, merchandise, an individual, stock, or a medical device.

Aspect 26: A method of wireless transmission performed by a transmission device, comprising: identifying a schedule to initiate transmission of a radio frequency (RF) signal configured to power an RF energy harvesting device; and transmitting the RF signal in accordance with the schedule.

Aspect 27: The method of Aspect 26, wherein the schedule indicates a time at which objects or RF energy harvesting devices are predicted to be present relative to the transmission device.

Aspect 28: The method of any of Aspects 26-27, wherein the schedule indicates a time interval in which transmission of RF signals configured to power the

RF energy harvesting device is permitted.

Aspect 29: The method of any of Aspects 26-28, wherein identifying the schedule further comprises receiving configuration information indicating the schedule.

Aspect 30: The method of any of Aspects 26-29, wherein identifying the schedule further comprises generating the schedule.

Aspect 31: The method of Aspect 30, wherein generating the schedule further comprises generating the schedule according to historical information regarding times at which objects were sensed or RF signals were transmitted.

Aspect 32: The method of any of Aspects 26-31, wherein the RF signal is in a 2.4 gigahertz band and has a transmit power of approximately 20 decibel milliwatts.

Aspect 33: The method of any of Aspects 26-32, wherein the RF signal is in a 900 megahertz band and has a transmit power of approximately 30 decibel milliwatts.

Aspect 34: The method of any of Aspects 26-33, further comprising sensing a presence of an object according to sensing information obtained by the transmission device, wherein transmitting the RF signal further comprises transmitting the RF signal in accordance with sensing the presence of the object.

Aspect 35: The method of Aspect 34, further comprising obtaining the sensing information from a sensor associated with the transmission device.

Aspect 36: The method of Aspect 35, wherein transmitting the RF signal further comprises transmitting the RF signal using a transmit component, wherein the sensor is separate from the transmit component.

Aspect 37: The method of Aspect 35, wherein the sensor comprises at least one of: a motion sensor, a light sensor, or an RF sensor.

Aspect 38: The method of Aspect 34, wherein the sensing information comprises a signal from a motion sensor associated with the transmission device indicating the presence of the object.

Aspect 39: The method of Aspect 34, wherein the sensing information comprises a signal from a light sensor associated with the transmission device indicating that a level of illuminance is lower than a threshold.

Aspect 40: The method of Aspect 34, further comprising receiving, from a passive infrared sensor associated with the transmission device, an indication that the object is present in a coverage area of the passive infrared sensor, the sensing information comprising the indication.

Aspect 41: The method of Aspect 34, further comprising receiving, from a Bluetooth low-energy (BLE) module of the transmission device, an indication based at least in part on a received signal, the sensing information comprising the indication.

Aspect 42: The method of Aspect 41, wherein the received signal is associated with a second BLE module of a second transmission device.

Aspect 43: The method of Aspect 34, wherein sensing the presence of the object further comprises sensing the presence of the object without receiving a transmission from the RF energy harvesting device.

Aspect 44: The method of Aspect 43, wherein sensing the presence of the object further comprises sensing the presence of the object while the RF energy harvesting device is in a dormant state.

Aspect 45: The method of any of Aspects 26-44, wherein the RF energy harvesting device is affixed to or associated with an object.

Aspect 46: The method of Aspect 45, wherein the object comprises at least one of: a cart, merchandise, an individual, or warehouse stock.

Aspect 47: The method of any of Aspects 26-46, wherein a time interval indicated by the schedule corresponds to operating hours or a restocking time of a store.

Aspect 48: The method of any of Aspects 26-47, wherein a time interval indicated by the schedule corresponds to a loading or unloading time of a warehouse.

Aspect 49: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48.

Aspect 50: An apparatus for wireless communication at a device, the apparatus comprising one or more memories and one or more processors coupled to the one or more memories, the one or more processors configured to cause the device to perform the method of one or more of Aspects 1-48.

Aspect 51: An apparatus for wireless communication, the apparatus comprising at least one means for performing the method of one or more of Aspects 1-48.

Aspect 52: A non-transitory computer-readable medium storing code for wireless communication, the code comprising instructions executable by one or more processors to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

Aspect 54: A device for wireless communication, the device comprising a processing system that includes one or more processors and one or more memories coupled with the one or more processors, the processing system configured to cause the device to perform the method of one or more of Aspects 1-48.

Aspect 55: An apparatus for wireless communication at a device, the apparatus comprising one or more memories and one or more processors coupled to the one or more memories, the one or more processors individually or collectively configured to cause the device to perform the method of one or more of Aspects 1-48.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,”“have,”“having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a transmission device, comprising:
one or more memories; and
one or more processors, coupled to the one or more memories, configured to cause the transmission device to:
sense a presence of an object according to sensing information obtained by the transmission device; and
transmit a radio frequency (RF) signal configured to power an RF energy harvesting device in response to sensing the presence of the object.

2. The apparatus of claim 1, wherein the one or more processors, to cause the transmission device to transmit the RF signal, are configured to cause the transmission device to initiate transmission of the RF signal in response to sensing the presence of the object.

3. The apparatus of claim 1, wherein the one or more processors are configured to cause the transmission device to obtain the sensing information from a sensor associated with the transmission device.

4. The apparatus of claim 3, wherein the one or more processors, to cause the transmission device to transmit the RF signal, are configured to cause the transmission device to transmit the RF signal using a transmit component, wherein the sensor is separate from the transmit component.

5. The apparatus of claim 3, wherein the sensor comprises at least one of:
a motion sensor,
a light sensor, or
an RF sensor.

6. The apparatus of claim 1, wherein the sensing information comprises a signal from a motion sensor associated with the transmission device indicating the presence of the object.

7. The apparatus of claim 1, wherein the sensing information comprises a signal from a light sensor associated with the transmission device indicating that a level of illuminance is lower than a threshold.

8. The apparatus of claim 1, wherein the one or more processors are further configured to cause the transmission device to receive, from a passive infrared sensor associated with the transmission device, an indication that the object is present in a coverage area of the passive infrared sensor, the sensing information comprising the indication.

9. The apparatus of claim 1, wherein the one or more processors are further configured to cause the transmission device to cease transmission of the RF signal after a configured length of time.

10. The apparatus of claim 1, wherein the one or more processors are further configured to cause the transmission device to:
receive second sensing information after initiating transmission of the RF signal, wherein the second sensing information does not indicate the presence of the object; and
cease transmission of the RF signal after receiving the second sensing information.

11. The apparatus of claim 1, wherein the one or more processors are further configured to cause the transmission device to avoid transmission of the RF signal while the transmission device waits for the presence of the object to be sensed.

12. The apparatus of claim 1, wherein the one or more processors, to cause the transmission device to sense the presence of the object, are configured to cause the transmission device to sense the presence of the object independently of receiving a transmission from the RF energy harvesting device.

13. The apparatus of claim 1, wherein the one or more processors, to cause the transmission device to sense the presence of the object, are configured to cause the transmission device to sense the presence of the object while the RF energy harvesting device is in a dormant state.

14. The apparatus of claim 1, wherein the one or more processors, to cause the transmission device to transmit the RF signal, are configured to cause the transmission device to transmit the RF signal in accordance with a schedule.

15. The apparatus of claim 1, wherein the RF signal is in a 2.4 gigahertz band and has an effective isotropic radiated power of up to 20 decibel milliwatts.

16. The apparatus of claim 1, wherein the RF signal is in a 900 megahertz band and has an effective isotropic radiated power of up to 34 decibel milliwatts.

17. The apparatus of claim 1, wherein the RF energy harvesting device is affixed to or associated with the object.

18. The apparatus of claim 1, wherein the object comprises at least one of:
a cart,
merchandise,
an individual,
a medical device, or
warehouse stock.

19. An apparatus for wireless communication at a transmission device, comprising:
one or more memories; and
one or more processors, coupled to the one or more memories, configured to cause the transmission device to:
identify a schedule to initiate transmission of a radio frequency (RF) signal configured to power an RF energy harvesting device; and
transmit the RF signal in accordance with the schedule.

20. The apparatus of claim 19, wherein the schedule indicates a time at which objects or RF energy harvesting devices are predicted to be present relative to the transmission device.

21. The apparatus of claim 19, wherein the schedule indicates a time interval in which transmission of RF signals configured to power the RF energy harvesting device is permitted.

22. The apparatus of claim 19, wherein the one or more processors, to cause the transmission device to identify the schedule, are configured to cause the transmission device to receive configuration information indicating the schedule.

23. The apparatus of claim 19, wherein the one or more processors, to cause the transmission device to identify the schedule, are configured to cause the transmission device to generate the schedule.

24. The apparatus of claim 23, wherein the one or more processors, to cause the transmission device to generate the schedule, are configured to cause the transmission device to generate the schedule according to historical information regarding times at which objects were sensed or RF signals were transmitted.

25. The apparatus of claim 19, wherein the one or more processors are configured to cause the transmission device to sense a presence of an object according to sensing information obtained by the transmission device, wherein, to cause the one or more processors to transmit the RF signal, the one or more processors are configured to cause the transmission device to transmit the RF signal in accordance with sensing the presence of the object.

26. The apparatus of claim 19, wherein a time interval indicated by the schedule corresponds to operating hours or a restocking time of a store or a loading or unloading time of a warehouse.

27. A method of wireless transmission performed by a transmission device, comprising:
sensing a presence of an object according to sensing information obtained by the transmission device; and
transmitting a radio frequency (RF) signal configured to power an RF energy harvesting device in response to sensing the presence of the object.

28. The method of claim 27, wherein transmitting the RF signal further comprises initiating transmission of the RF signal in response to sensing the presence of the object.

29. A method of wireless transmission performed by a transmission device, comprising:
identifying a schedule to initiate transmission of a radio frequency (RF) signal configured to power an RF energy harvesting device; and
transmitting the RF signal in accordance with the schedule.

30. The method of claim 29, wherein the schedule indicates a time at which objects or RF energy harvesting devices are predicted to be present relative to the transmission device or a time interval in which transmission of RF signals configured to power the RF energy harvesting device is permitted.
